(19) United States
(12) Patent Application Publication
(10) Pub. No.: US 2005/0124713 A1
(43) Pub. Date: Jun. 9, 2005

(54) Brightness enhancing film composition

(76) Inventors: Clinton L. Jones, Somerset, WI (US); David B. Olson, Marine on St. Croix, MN (US); Judith M. Invie, Woodbury, MN (US); Olester Benson JR., Woodbury, MN (US); Richard J. Pokorny, Maplewood, MN (US); Scott R. Kaytor, Woodbury, MN (US); Tetsuya Toma, Woodbury, MN (US); Scott M. Tapio, Falcon Heights, MN (US); Bert T. Chien, Minneapolis, MN (US); Daniel W. Hennen, Cottage Grove, MN (US); Jung-Sheng Wu, Woodbury, MN (US)

Correspondence Address: 3M INNOVATIVE PROPERTIES COMPANY, PO BOX 33427, ST. PAUL, MN, 55133-3427, US

(21) Appl. No.: 10/727,830

(22) Filed: Dec. 4, 2003

(51) Int. Cl. C08G 2/00

(52) U.S. Cl. 522/6

(57) ABSTRACT

Polymerizable compositions particularly useful for brightness enhancing films.

### FIELD

Polymerizable compositions particularly useful for brightness enhancing films.

### BACKGROUND

Certain microreplicated optical products, such as described in U.S. Pat. Nos. 5,175,030 and 5,183,597, are commonly referred to as a “brightness enhancing films”. Brightness enhancing films are utilized in many electronic products to increase the brightness of a backlit flat panel display such as a liquid crystal display (LCD) including those used in electroluminescent panels, laptop computer displays, word processors, desktop monitors, televisions, videocameras, and automotive and avionic displays.

Brightness enhancing films desirably exhibit specific optical and physical properties. The index of refraction of a brightness enhancing film is related to the brightness gain or “gain” produced. Improved brightness allows the electronic product to operate more efficiently by using less power to light the display, thereby reducing the power consumption, placing a lower heat load on its components, and extending the lifetime of the product.

Brightness enhancing films are prepared from high index of refraction monomers that are cured or polymerized. See for example U.S. Pat. Nos. 5,908,874; 5,932,626; 6,107,364; 6,280,063; and 6,355,754 as well as EP 1 014113 and WO 03/076528.

Although various polymerizable compositions that are suitable for the manufacture of brightness enhancing films have been described, industry would find advantage in certain formulas having improved properties.

### SUMMARY

The present invention discloses a brightness enhancing film comprising the reaction product of a composition comprising at least 25% of a first monomer consisting of 2,4,6-tribromophenoxyethyl(meth)acrylate, less than 50% of a second monomer having a refractive index of at least 1.54; and at least one crosslinking agent.

The composition comprises at least one photoinitiator having an absorbance greater than 0.5 at a wavelength of at least 360 nm for a 0.10 wt-% acetonitrile solution when measured with a path length of 1 cm. The absorbance is preferably greater than about 0.75 and more preferably about 1 or greater. The absorbance preferably approaches zero at a wavelength of about 400 nm.

In one embodiment, the composition comprises 1.5 pph to 5 pph of photoinitiator(s) having the characteristic just described. In another embodiment, the composition comprises 0.75 wt-% to 3.0 wt-% of a bisacylphosphine oxide photoinitiator.

The polymerizable composition described herein may also be advantageous for other optical materials.

### BRIEF DESCRIPTION OF THE DRAWING

FIG. 1 is a perspective view of an exemplary microstructure-bearing optical product of the present invention. FIG. 1 is not to scale and is intended to be merely illustrative and non-limiting.

FIG. 2 is a schematic view of an illustrative backlit liquid crystal display including the brightness enhancing film of the invention.

### DETAILED DESCRIPTION

As used within the present description:

“Index of refraction,” or “refractive index,” refers to the absolute refractive index of a material (e.g., a monomer) that is understood to be the ratio of the speed of electromagnetic radiation in free space to the speed of the radiation in that material, with the radiation being sodium yellow light at a wavelength of about 589.3 nm. Index of refraction can be measured using an Abbe refractometer, available commercially, for example, from Fisher Instruments of Pittsburgh, Pa. It is generally appreciated that the measured index of refraction can vary to some extent depending on the instrument.

“(Meth)acrylate” refers to both acrylate and methacrylate compounds.

“Polymerizable composition” refers to a chemical composition that contains one or more polymerizable components as described in the present specification, including at least the identified monomers that can be cured or polymerized.

“Brightness enhancing films” include microstructure-bearing articles having a regular repeating pattern of symmetrical tips and grooves. Other examples of groove patterns include patterns in which the tips and grooves are not symmetrical and in which the size, orientation, or distance between the tips and grooves is not uniform. Examples of brightness enhancing films are described in Lu et al., U.S. Pat. No. 5,175,030, and Lu, U.S. Pat. No. 5,183,597, said descriptions being incorporated herein by reference.

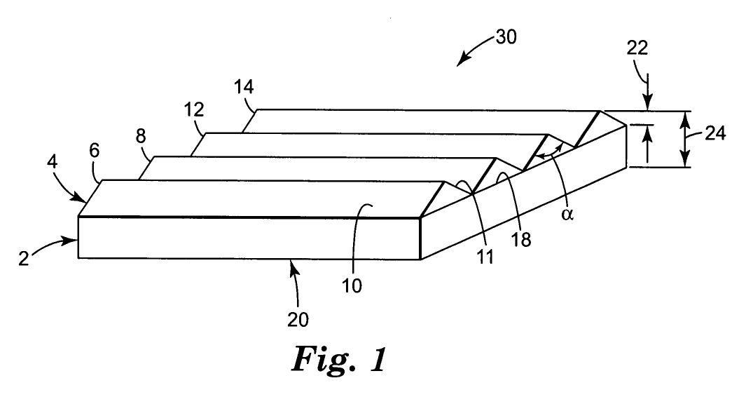

Referring to FIG. 1, the brightness enhancing film 30 of the invention generally comprises base layer 2 and optical layer 4. Optical layer 4 comprises a linear array of regular right prisms, identified as prisms 6, 8, 12, and 14. Each prism, for example, prism 6, has a first facet 10 and a second facet 11. The prisms 6, 8, 12, and 14 are formed on base 2 that has a first surface 18 on which the prisms are formed and a second surface 20 that is substantially flat or planar and opposite first surface 18. By right prisms it is meant that the apex angle α is typically about 90°. However, this angle can range from 70° to 120° and is preferably from 80° to 100°, and, it is not necessary that the corner be sharp, but it can be either sharp or rounded. The prism facets need not be identical, and the prisms may be tilted with respect to each other. The relationship between the total thickness 24 of the optical article, and the height 22 of the prisms, is not critical. Still, it is desirable to use relatively thinner optical layers with well-defined prism facets. A typical ratio of prism height 22 to total thickness 24 is generally between 25/125 and 2/125.

The present invention relates to a brightness enhancing film comprising the reaction product of a polymerizable resin composition. The polymerizable resin composition comprises a first and a second monomer, each having a refractive index of at least 1.54. The composition further comprises at least one crosslinking agent and optionally at least one reactive diluent. The composition of the invention is polymerizable by irradiation with ultraviolet or visible light in the presence of photoinitiator.

The compositions of the present invention comprise a least one photoinitiator having certain absorption characteristics. Absorption spectra of various photoinitiators is typically reported by the supplier. Alternatively, the spectra of a photoinitiator can be measured with standard techniques. The photoinitiators employed herein exhibit an absorbance greater than 0.5 at a wavelength of at least 360 nm when measured in a 0.10 wt-% solution in acetonitrile utilizing a path length of 1 cm. Preferably, the absorbance is at least about 0.75 and more preferably about 1 or greater. For some preferred embodiments, the absorbance is greater than 0.5 (e.g. 0.75, about 1) at a wavelength of 380. The absorption spectrum typically approaches zero at a wavelength of about 400 nm. Accordingly, the photoinitiator is activated and cleaves forming free radicals at wavelengths between 360 nm and 400 nm.

A single photoinitiator or blends thereof may be employed in the brightness enhancement film of the invention. In general the photoinitiator(s) are at least partially soluble (e.g. at the processing temperature of the resin) and substantially colorless after being polymerized. The photoinitiator may be (e.g. yellow) colored, provided that the photoinitiator is rendered substantially colorless after exposure to the UV light source.

Photoinitiators that exhibit the absorption spectra characteristics just described include monoacylphosphine oxide and bisacylphosphine oxide. Commercially available mono or bisacylphosphine oxide photoinitiators include 2,4,6-trimethylbenzoydiphenylphosphine oxide, commercially available from BASF (Charlotte, N.C.) under the trade designation “Lucirin TPO”; ethyl-2,4,6-trimethylbenzoylphenyl phosphinate, also commercially available from BASF under the trade designation “Lucirin TPO-L; and bis(2,4,6-trimethylbenzoyl)-phenylphosphine oxide commercially available from Ciba Specialty Chemicals under the trade designation ”Irgacure 819”.

The amount of photoinitiator is dependent on the type of photoinitiator. For embodiments wherein the photoinitiator generates two radicals, such as the mono acyl phosphine oxide (e.g. Lucirin TPO), the amount of photoinitiator is greater than 1.0 pph based on the total weight of the polymerizable composition, preferably at least about 1.5 pph, and more preferably at least 1.75 pph. (e.g. 2.0, 2.2, 2.4, 2.6 pph) For embodiments wherein the photoinitiator generates more than two radicals, the amount of photoinitiator is proportionately adjusted. For example, in the case of bisacylphosphine oxide (e.g. Irgacure 819), wherein four radicals are generated, the preferred amount of photoinitiator is greater than 0.5 wt-%, preferably at least about 0.75 wt-%, and more preferably about 1 wt-%. Typically, no more than about 3.0 wt-% of bisacylphosphine oxide is employed. Greater than 5 wt-% photoinitiator is generally disadvantageous in view of the tendency to cause yellow discoloration of the brightness enhancing film. Other photoinitiators and photoinitiator combinations having similar solubility and similar UV absorption characteristics to that of acylphosphine may also suitably be employed as may be determined by one of ordinary skill in the art.

It has been found that these particular kinds and amounts of photoinitiator result in higher conversion of monomeric components to polymeric components. The conversion can be determined with infrared spectroscopy as described in further detail in the subsequently described test methods. Higher conversion is indicative of a reduction in residual monomer. Higher conversion is surmised to be amenable to other improved properties such as increased hardness. In comparison to the same resin formulation employing 1 pph of a photoinitiator having different absorption characteristics (e.g. commercially available under the trade designation “Darocur 1173”), the compositions of the present invention have been found to exhibit increased hardness as determined by nanoindentation. For example, the top down hardness as determined by the test method described at pp. 27-30 of WO03/089963 was found to be greater than 350 MPa (e.g. 360MPa, 370MPa, 380MPa).

Due to the higher conversion, the brightness enhancing film of the invention is also surmised to be less susceptible to groove tip deformation. As described in greater detail in U.S. Pat. No. 5,626,800, incorporated herein by reference, groove tip deformation (also referred to as groove tip impression) results when a weight or force is applied to a brightness enhancing film or when an object strikes the film. Groove tip deformation results in visible defects such as dark spots in the brightness enhancing film.

Alternatively or in addition thereto, the brightness enhancing film of the invention is surmised to have increased abrasion resistance, increased solvent resistance, and increased scratch resistance such as evaluated with the stylus-type scratch machine as described in U.S. application Ser. No. 10/662085 filed Sep. 12, 2003 incorporated herein by reference.

The polymerizable composition of the invention comprises a major portion of a first and second monomer, each having a refractive index of at least 1.54 (e.g. 1.55). Further, both the first and the second monomer, as well as any optional reactive ingredients, preferably comprise (meth)acrylate functional groups.

The first monomer is present in the composition at an amount of at least 25 wt-% (e.g. 26 wt-%, 27 wt-%, 28 wt-%, 29 wt-%). The first monomer is halogenated (i.e. brominated), consisting of 2,4,6-tribromophenoxyethyl(meth)acrylate. This monomer is commercially available from Daiichi Kogyo Seiyaku Co. Ltd (Kyoto, Japan) under the trade designation “BR-31”. Typically, the amount of this monomer is no greater than 50 wt-%. The amount of this monomer is preferably present in amounts ranging from about 30 wt-% to about 45 wt-% (including integers between 30 and 45).

In addition to the first monomer, the polymerizable composition of the invention comprises a second monomer (e.g. oligomer) having a refractive index of at least 1.54 (e.g. 1.55, 1.56, 1.57, 1.58, 1.59, 1.60). This second monomer is different than the first monomer. The second monomer typically comprises a substantially greater molecular weight than the first monomer. The second monomer may also be halogenated (e.g. brominated). Typically, the second monomer is present in an amount of at least 10 wt-% and typically at least 15 wt-%. Preferably the amount of the second monomer ranges from about 20 wt-% to about 40 wt-% (including integers between 20 and 40).

A preferred second monomer comprises a brominated bisphenol A diacrylate such as those having the general structure: 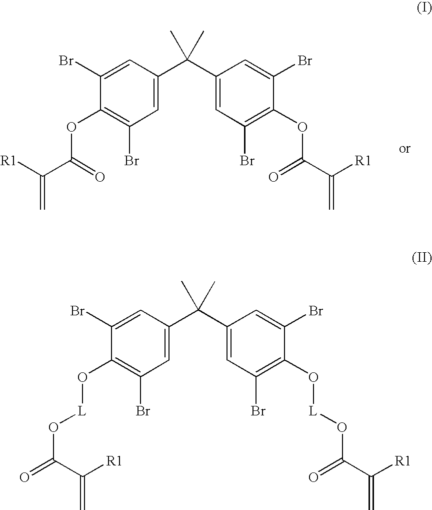
In each of structures I and II, R1 is hydrogen or methyl. In structure II, L is a linking group. L may comprise a branched or linear C₂-C₁₂ alkyl group. Preferably the alkyl group comprises no more than 8 carbon atoms and more preferably no more than 6 carbon atoms. Alternatively, L is —CH₂CH(OH)CH₂—.

The second monomer may be synthesized or may be commercially available. It is commonly appreciated that although the second monomer may comprise a major portion (e.g. at least about 80 wt-%) of structures I and II just described, the presence of other reaction products are also typically present.

One particularly preferred second monomer comprising a major portion of acrylic acid 4-[1-(4-acyloyloxy-3,5-dibromo-phenyl)-1-methyl-ethyl]-2,6-dibromo phenyl ester is commercially available from UCB Corporation, Smyrna, Ga. under the trade designation “RDX-51027”.

The polymerizable resin composition optionally, yet preferably comprises up to about 15 wt-% reactive diluents to improve the processability of the resin. Reactive diluents are mono- or di-functional (meth)acrylate-functional monomers typically having a refractive index greater than 1.50. Such reactive diluents are typically non-halogenated (e.g. non-brominated). Suitable reactive diluents include for example phenoxyethyl (meth)acrylate, phenoxy-2-methylethyl(meth)acrylate, phenoxyethoxyethyl(meth)acrylate, 3-hydroxy-2-hydroxypropyl(meth)acrylate, benzyl(meth)acrylate, 4-(1-methyl-1-phenethyl)phenoxyethyl(meth)acrylate and phenylthioethyl(meth)acrylate.

The polymerizable resin composition of the invention comprises at least one crosslinking agent. The crosslinking agent is preferably also (meth)acrylate-functional having at least three reactive groups. A preferred crosslinker includes hexa-functional aromatic urethane acrylate oligomer commercially available from UCB Corporation, Smyrna, Ga. under the trade designations “EB 9220” and “EB 220”.

Surfactants such as fluorosurfactants and silicone based surfactants can optionally be included in the polymerizable composition to reduce surface tension, improve wetting, allow smoother coating and fewer defects of the coating, etc.

Polymeric beads, inorganic fillers, and/or pigments can be added to the polymerizable composition in order to improve processing, to impart slip and scratch resistance to the polymerized material, or to affect optical properties of the polymerized material. Examples of useful polymeric beads include those made of polystyrene, polyacrylates, copolymers of styrene and acrylates, polyethylene, polypropylene, polytetrafluoroethylene, or combinations thereof. Examples of inorganic fillers and pigments include solid or hollow glass beads, silica, zirconia, aluminum trihydroxide, and titanium dioxide. The mean particle size can be between 1 and 20 micrometer (um), and the particles can be included in the polymerizable composition in an amount in the range from about 0.25 to 7 weight percent, more typically from about 0.25 to 2 weight percent.

As described in Lu and Lu et al., a microstructure-bearing article (e.g. brightness enhancing film) can be prepared by a method including the steps of (a) preparing a polymerizable composition (i.e. the polymerizable composition of the invention); (b) depositing the polymerizable composition onto a master negative microstructured molding surface in an amount barely sufficient to fill the cavities of the master; (c) filling the cavities by moving a bead of the polymerizable composition between a preformed base and the master, at least one of which is flexible; and (d) curing the composition. The master can be metallic, such as nickel, nickel-plated copper or brass, or can be a thermoplastic material that is stable under the polymerization conditions, and that preferably has a surface energy that allows clean removal of the polymerized material from the master.

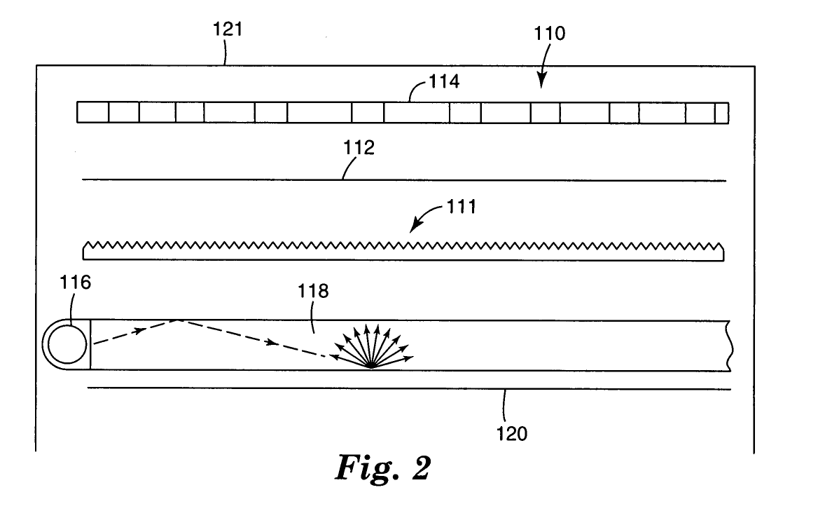

The brightness enhancing film of the invention is usefully employed in a display for the purpose of improving the gain. A schematic view of an illustrative backlit liquid crystal display generally indicated at 110 in FIG. 2. In the actual display, the various components depicted are often in contact with the brightness enhancing film. The brightness enhancing film 111 of the present invention is generally positioned between a light guide 118 and a liquid crystal display panel 114. The liquid crystal display panel typically includes an absorbing polarizer on both surfaces. Thus, such absorbing polarizer is positioned adjacent to the brightness enhancing film of the invention. The backlit liquid crystal display can also include a light source 116 such as a fluorescent lamp and a white reflector 120 also for reflecting light also toward the liquid crystal display panel. The brightness enhancing film 111 collimates light emitted from the light guide 118 thereby increasing the brightness of the liquid crystal display panel 114. The increased brightness enables a sharper image to be produced by the liquid crystal display panel and allows the power of the light source 116 to be reduced to produce a selected brightness. The backlit liquid crystal display is useful in equipment such as computer displays (laptop displays and computer monitors), televisions, video recorders, mobile communication devices, handheld devices (i.e. cellphone, PDA), automobile and avionic instrument displays, and the like, represented by reference character 121.

The display may further include another optical film 112 positioned between the brightness enhancing film and the liquid crystal display panel 114. The other optical film may include for example a diffuser, a reflective polarizer, or a second brightness enhancing film. Other optical films may be positioned between optical film 112 and the liquid crystal display panel 114 or between the brightness enhancing film 111 and the light guide 118, as are known in the art.

Examples of polarizing films include those described in U.S. Pat. Nos. 5,825,543 and 5,783,120, each of which are incorporated herein by reference. The use of these polarizer films in combination with a brightness enhancing film has been described in U.S. Pat. No. 6,111,696. Another example of a polarizing film is described in U.S. Pat. No. 5,882,774. One example of such films that are available commercially are the multilayer films sold under the trade designation DBEF (Dual Brightness Enhancement Film) from 3M Company. Multilayer polarizing optical films have been described, for example in U.S. Pat. No. 5,828,488.

The polymerizable composition described herein may be advantageous for other optical materials such as microstructure-bearing optical articles (e.g. films). Exemplary optical materials include optical lenses such as Fresnel lenses, optical films, such as high index of refraction films e.g., microreplicated films such as totally internal reflecting films, or brightness enhancing films, flat films, multilayer films, retroreflective sheeting, optical light fibers or tubes, and others. The production of optical products from high index of refraction polymerizable compositions is described, for example, in U.S. Pat. No. 4,542,449, the disclosure of which is incorporated herein by reference.

Advantages of the invention are further illustrated by the following examples, but the particular materials and amounts thereof recited in the examples, as well as other conditions and details, should not be construed to unduly limit the invention. All percentages and ratios herein are by weight unless otherwise specified.

### EXAMPLES

Test Methods

1. Fourier Transform Infrared Spectroscopy (“FTIR”)

FTIR spectra was recorded with use of an Avatar 370 FTIR Thermo Nicolet, Madison, Wis. equipped with Nicolet Smart DuraScope to provided attenuated total reflection capability. Samples of the brightness enhancing film were place horizontally on the stage and tested with prisms aligned parallel to the front of the instrument with the pressure bar reading set at level 6. OMNIC software included with the FTIR equipment was used to analyze the IR peaks. A macro program was used to analyze results. The macro program divides the peak height at about 1404 cm⁻¹ (i.e. monomeric (meth)acrylate peak) by the peak height at about 1440 cm⁻¹ (a peak that is invariant over the course of the reaction), reporting a ratio of conversion. The ratio decreases as the amount of monomer is reacted. Thus, a low value is indicative of higher conversion. The average ratio of three samples is reported.

2. Gain Test Method

Gain, the difference in transmitted light intensity of an optical material compared to a standard material, was measured on a SpectraScan™ PR-650 SpectraColorimeter available from Photo Research, Inc, Chatsworth, Calif. Results of this method for each example formed below are reported in the RESULTS section below. Film samples are cut and placed on a Teflon light cube that is illuminated via a light-pipe using a Foster DCR II light source.

The ingredients employed in the examples are described in Table I as follows:

| Generic Description | Trade Designation |
|---|---|
| First monomer | BR-31 (Refractive Index = 1.58) |
| Second Monomer | RDX-51027 (Refractive Index = 1.60) |
| Crosslinker | EB-9220 (Refractive Index = 1.51) |
| Photoinitiator | Darocur 1173 |
| Photoinitiator | Lucirin TPO |
| Diluent | phenoxyethyl (meth)acrylate (“PEA”) |
| | (Refractive Index = 1.51) |

### Comparative Example A

A mixture of 12.5 wt-% PEA, 37.5 wt-% BR-31, 30 wt-% RDX-51027, 20 wt-% EB-9220, and 1 pph Darocur 1173 was prepared.

### Comparative Example B

A mixture of 12.5 wt-% PEA, 37.5 wt-% BR-31, 30 wt-% RDX-51027, 20 wt-% EB-9220, and 1 pph Lucirin TPO was prepared.

### Example 1

Comparative Example B was repeated with the exception that 2 pph Lucirin TPO was employed.

### Example 2

Example 1 was repeated with the exception that 3 pph Lucirin TPO was employed.

### Example 3

Example 1 was repeated with the exception that 5 pph Lucirin TPO was employed.

The Comparative Examples and each of the Examples were prepared into brightness enhancing films as described in U.S. Pat. Nos. 5,175,030 and 5,183,597 or co-assigned U.S. patent application Ser. No. 10/436377 filed May 12, 2003. The micro-prismatic structures have a 90° apex angles as defined by the slope of the sides of the prisms with the mean distance between adjacent apices being about 24 micrometers. The apex of the prism vertices were sharp.

The FTIR and gain measured for each of the brightness enhancement films was measured and reported as follows.

| | FTIR | Gain |
|---|---|---|
| Comparative Example A | 0.91 | 1.692 |
| Comparative Example B | 0.87 | 1.695 |
| Example 1 | 0.85 | 1.630 |
| Example 2 | 0.84 | 1.672 |
| Example 3 | 0.83 | 1.693 |

The results show that a higher conversion was obtained with the polymerizable resin composition by selection of the kind and amount of photoinitiator. All samples have suitable gain for use as brightness enhancing films.

1. A brightness enhancing film comprising the reaction product of a composition comprising:
a) at least 25% of a first monomer consisting of 2,4,6-tribromophenoxyethyl(meth)acrylate
b) less than 50% of a second monomer having a refractive index of at least 1.54;
c) at least one crosslinking agent; and
d) 1.5 pph to 5 pph of a photoinitiator having an absorbance greater than 0.5 at a wavelength of at least 360 nm for a 0.10 wt-% acetonitrile solution with a path length of 1 cm.

2. The brightness enhancing film of claim 1 wherein the absorbance of the photoinitiator is greater than about 0.75 at a wavelength of at least 360 nm.

3. The brightness enhancing film of claim 1 wherein the absorbance of the photoinitiator is greater than about 1 at a wavelength of at least 360 nm.

4. The brightness enhancing film of claim 1 wherein the absorbance of the photoinitiator approaches zero at a wavelength of about 400 nm.

5. The brightness enhancing film of claim 1 wherein the photoinitiator forms two free radicals.

6. The brightness enhancing film of claim 5 wherein the photoinitiator comprises a monoacylphosphine oxide.

7. The brightness enhancing film of claim 1 wherein the second monomer has a refractive index of at least 1.59.

8. The brightness enhancing film of claim 1 wherein the second monomer is a (meth)acrylate functional monomer.

9. The brightness enhancing film of claim 8 wherein a major amount of the second monomer has the structure 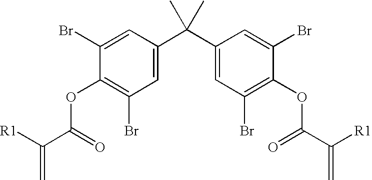
wherein R1 is hydrogen or methyl.

10. The brightness enhancing film of claim 8 wherein a major amount of the second monomer has the structure 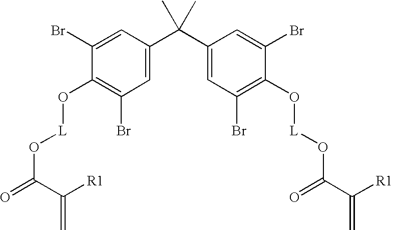
wherein R1 is hydrogen or methyl; and
L is a linking group selected from
linear C₂-C₁₂ alkyl groups;
branched C₂-C₁₂ alkyl groups; and
—CH₂CH(OH)CH₂—.

11. The brightness enhancing film of claim 1 wherein the crosslinking agent comprises a hexa-functional aromatic urethane oligomer.

12. The brightness enhancing film of claim 1 wherein the composition further comprises at least one non-halogenated (meth)acrylate-functional comonomer.

13. The brightness enhancing film of claim 12 wherein the at least one non-halogenated (meth)acrylate-functional comonomer is present in the composition in an amount ranging from about 10 wt-% to 15 wt-%.

14. An article comprising the brightness enhancing film of claim 1 and a second optical film in contact with the brightness enhancing film.

15. The article of claim 14 wherein the second optical film is a diffuser.

16. The article of claim 14 wherein the second optical film is an absorbing polarizer.

17. The article of claim 14 wherein the second optical film is a reflective polarizer.

18. The article of claim 14 wherein the second optical film comprises a prismatic structure.

19. A brightness enhancing film comprising the reaction product of a composition comprising:
a) at least 25% of a first monomer consisting of 2,4,6-tribromophenoxyethyl(meth)acrylate;
b) less than 50% of a second monomer having a refractive index of at least 1.54;
c) at least one crosslinking agent; and
d) 0.75 wt-% to 3.0 wt-% of a bisacylphosphine oxide photoinitiator.

20. An article comprising the brightness enhancing film of claim 19 and a second optical film in contact with the brightness enhancing film.

21. The article of claim 20 wherein the second optical film is a diffuser.

22. The article of claim 20 wherein the second optical film is an absorbing polarizer.

23. The article of claim 20 wherein the second optical film is a reflective polarizer.

24. A polymerizable resin composition comprising:
a) at least 25% of a first monomer consisting of 2,4,6, tribromophenoxyethyl(meth)acrylate
b) less than 50% of a second monomer having a refractive index of at least 1.54;
c) at least one crosslinking agent; and
d) 1.5 pph to 5 pph of a photoinitiator having an absorbance greater than 0.5 at a wavelength of at least 360 nm for a 0.10 wt-% acetonitrile solution with a path length of 1 cm or 0.75 wt-% to 3.0 wt-% of a bisacylphosphine oxide photoinitiator.

25. An optical material comprising the reaction product of claim 24.

26. The optical material of claim 24 wherein the material is a film.

27. The optical material of claim 24 wherein the film comprises a microstructured surface.
